(19) United States
(12) Patent Application Publication
(10) Pub. No.: US 2021/0100713 A1
(43) Pub. Date: Apr. 8, 2021

(54) Mobility Training Apparatus

(71) Applicant: Josua Engineering AG, Roggwil (CH)

(72) Inventor: Murat Altinbas, Roggwil (CH)

(21) Appl. No.: 16/603,272

(22) PCT Filed: Apr. 9, 2018
(86) PCT No.: PCT/IB2018/052455

§ 371 Date: Oct. 7, 2019

(30) Foreign Application Priority Data
Apr. 10, 2017 (CH) 00483/17

(51) Int. Cl. A61H 1/02; A61H 15/00

(52) U.S. Cl. CPC A61H 1/0237; A61H 2205/10; A61H 2015/0014; A61H 2015/0042; A61H 2015/0071; A61H 2201/0165; A61H 2201/1207; A61H 2201/1261; A61H 2201/1623; A61H 2201/1638; A61H 2201/1669; A61H 2201/169; A61H 2201/5053; A61H 2203/0406; A61H 2205/081; A61H 15/0078

(57) ABSTRACT

Mobility training apparatus 1 having a training means 2 for training muscles M and muscle fascia of the human body, wherein the training means 2 comprises at least one elongated training body 21, and is automatically movable up and down in a guide 3 by a drive in the vertical direction.

The present invention relates to a mobility training apparatus according to the preamble of patent claim 1.

Due to lack of training and stretching, especially with advancing age, the muscles of the human body shorten and stiffen, also due to fascial adhesions. In addition to a loss of mobility, this often leads to arthritis pain when walking or performing other physical activities.

To counter this effect, the muscles and muscle fascia can be “trained” by appropriate means. In particular, stretching exercises and releasing fascial adhesions are useful for maintaining mobility or recovering lost mobility. With increasing age, the training effort is greater or more tedious, since a good training effect is achieved when the pain threshold is approached, reached or even exceeded. Thus, for people who are less disciplined or very sensitive to pain, the time required for a sufficient training is often not in good proportion to the achieved training effect.

To counter this, it is often recommended to hire a so-called personal trainer, who strengthens the motivation and perseverance on the one hand and who can step in to reinforce stretching exercises on the other hand, so that the desired stretching effect is achieved even without special effort. However, this is cumbersome because appointments must be made, and expensive because a personal trainer must obviously be remunerated in addition to the training room or training equipment.

### SUMMARY OF THE INVENTION

The object of the present invention is to provide a mobility training apparatus for making the different muscle groups, muscle fascia and thus the entire body durably faster and easier to move.

This object is achieved by a mobility training apparatus with the features of patent claim 1. Further features and embodiments will become apparent from the dependent claims and the advantages thereof are explained in the following description.

### BRIEF DESCRIPTION OF THE DRAWINGS

The drawings show:

FIG. 1 Mobility training apparatus

FIGS. 2a-b Training body, perspective and profile view

FIG. 3 Mobility training apparatus in use for the front thigh muscles

FIG. 4 Mobility training apparatus in use for the rear leg muscles

FIG. 5 Mobility training apparatus in use for the lateral trunk muscles

FIG. 6 Mobility training apparatus with curved and crossed struts

The figures represent possible embodiments which will be explained in the following description. Hereinafter, the terms “horizontal,” “vertical,” “upper,” and “lower” are to be understood by reference to gravity when the mobility training apparatus 1 is in the use position.

### DETAILED DESCRIPTION OF THE PREFERRED EMBODIMENTS

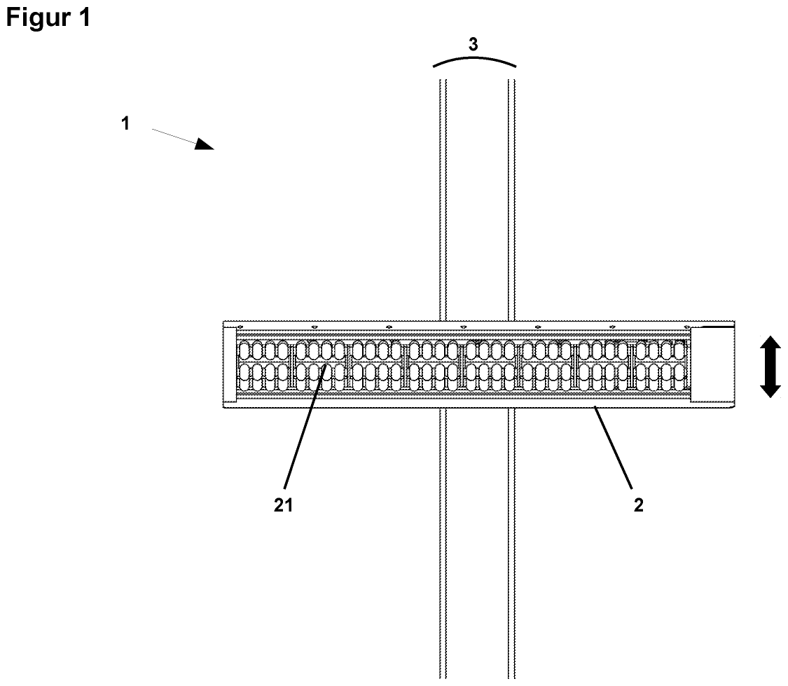

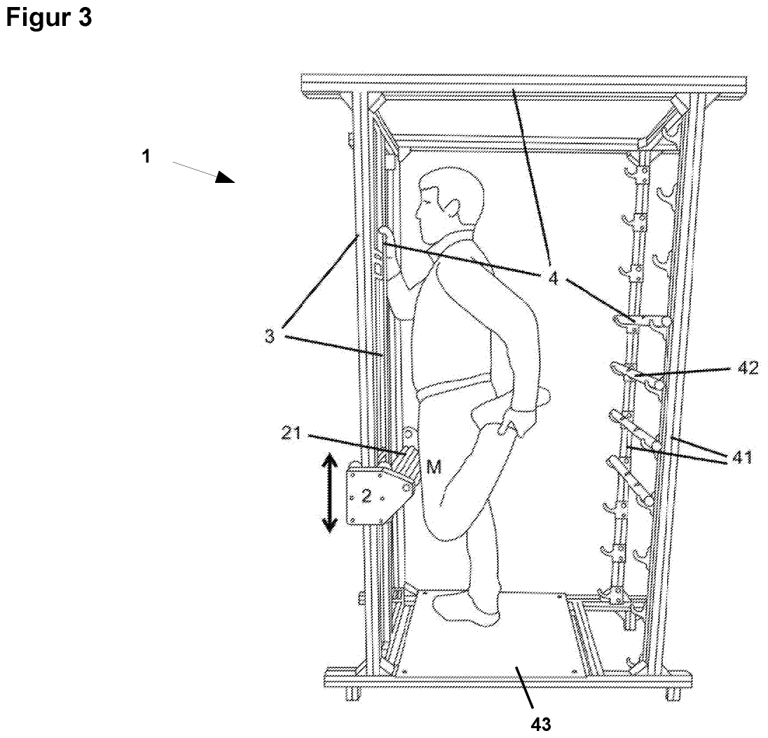

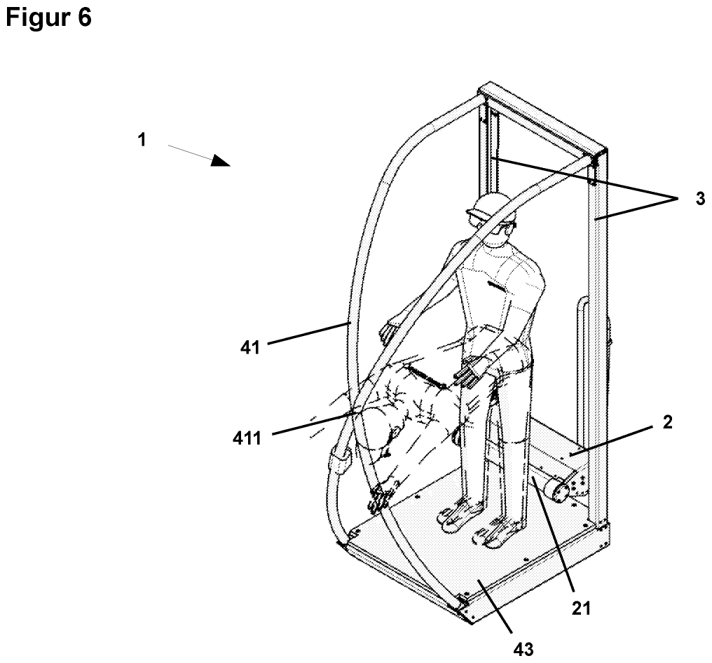

The mobility training apparatus 1 according to the invention comprises a training means 2 with at least one elongated training body 21 for training a muscle M or muscle fascia of the human body (FIG. 1). The training means 2 is connected to a vertical guide 3 and movable automatically up and down by a drive, in the vertical direction along the guide 3. Depending on the embodiment of the invention, the guide 3 consists of one part (FIG. 1) or of two parallel parts on which the training means 2 is arranged at both ends (FIGS. 3, 4, 5 and 6). Depending on the embodiment of the invention, the drive is either integrated in the mobile training means 2 or connected to the guide 3. In possible embodiments of the invention, the training body 21 is mounted rotatably on the training means 2 and can rotate in a vertical plane relatively to the training means 2.

The training body 21 serves to train a muscle M or muscle fascia of the human body, in particular stretched muscle fascia M, in order to improve their stretchability. In order to achieve this, the training body 21 may perform different functions, such as e.g. massaging, tapping or vibrating, wherein it is not about performing a massage, but rather about releasing fascial adhesions. The training body 21 is moved up and down along the guide 3 along the stretched muscle fascia M by moving the training means 2, and performs the intended function on the muscle fascia M. Depending on the muscle M, its length and position in the body, this automatic movement is longer or shorter and performed in the upper or lower part the body. This way, the stretched muscle fascia M are additionally trained, fascial adhesions are released and the muscle M is trained to be more flexible. As a result of the massaging, tapping or vibrating function of the training body 21, the stretched muscle fascia M are stretched, elongated and extended even further locally. This way, lost mobility is restored or additional mobility is gained.

Depending on the desired function of the training body 21, it can rotate about its longitudinal axis L and/or vibrate. The surface of the training body 21 may also be designed differently, e.g. with rolls of different thickness, with nubs, with round, wavy or spiral elevations which exert an irregular force on the muscle M or the muscle fascia during vibration and rotation, thus stimulating and stretching it. Advantageously, the training body 21 and/or individual components thereof are covered with a cloth or with leather. The training body 21 may also consist of several parts with different structures along its longitudinal axis, so that a different effect on the muscle fascia is achieved depending on the position of the muscle M. In one possible embodiment, these parts can also be rotated and/or vibrated independently of each other. The vibration or rotation of the training means 2 may be created by an adequate design of the vertical guide 3 or the mobility training apparatus 1 may include an additional drive, e.g. in the training means 2, which creates this vibration or rotation.

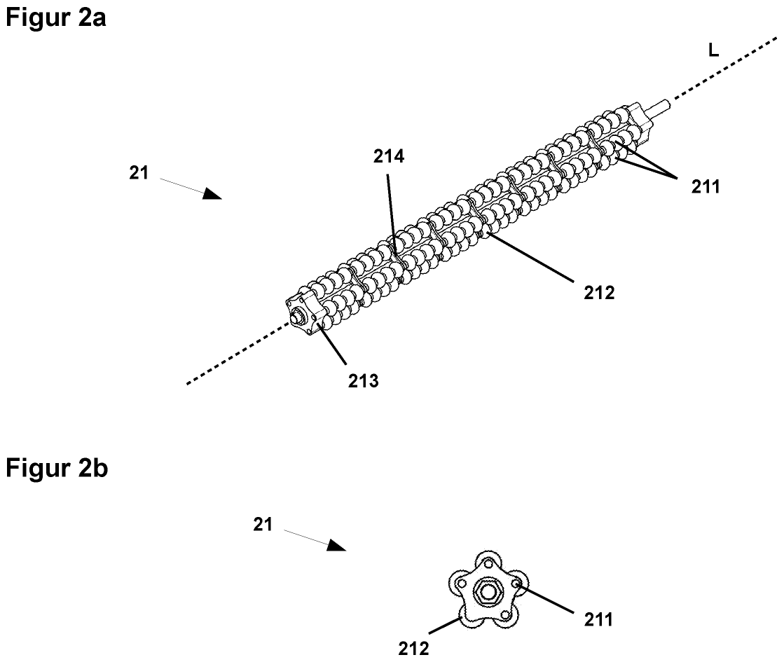

In the preferred embodiment of the invention, the training body 21 has at least five rods 211 arranged at regular intervals about the longitudinal axis L of the training body 21 and parallel thereto (FIG. 2a). With five rods 211, the training body thus has a 5-sided profile (FIG. 2b), with 6 rods a hexagonal profile, etc. Small balls or rollers 212 are arranged on these rods 211 and depending on the embodiment, they may have different profiles and may freely rotate about the rods 211 or be rigidly secured thereto (FIGS. 2a-b). It is particularly advantageous if the shape of the balls 212 is adapted for releasing fascial adhesions. Good results have been achieved with saucer-shaped or flattened balls 212 whose width parallel to the longitudinal axis L of the training body 21 is smaller than their diameter in the radial direction. Balls 212 having a diameter between 1 cm and 2 cm and a width ⅓ narrower than their diameter, e.g. a diameter of 1.5 cm and a width of 1 cm, are ideal for releasing fascial adhesions. When the training body 21 is rotated about its longitudinal axis L, the balls 212 roll on the muscles M or muscle fascia to be trained and have a massaging effect. Since the training body 21 does not have a circular but a polygonal profile, its radius is not constant depending on the angle of rotation. Rotating the training body 21 about its longitudinal axis L thus has a tapping effect on the muscle M or muscle fascia. A vibrating effect can also be achieved with this tapping effect at a higher rotational speed. The embodiment of FIG. 2a shows a training body 21 with rods 211 connected to a plate 213 at both ends. The training body 21 may be connected to the training means 2 on one side only or on both sides. It is particularly advantageous if at least one spacer 214 is arranged along the rods 211, which connects the rods 211 to one another and ensures good rigidity and stability of the training body 21, even if a muscle M is pressed thereon with great force (FIG. 2a). For more efficient training of larger or longer muscle parts M and of the associated muscle fascia, such as in the legs, the training means 2 may also consist of several training bodies 21 performing the same or different rotational or vibrational movements.

In a simple embodiment of the invention, the guide 3 of the mobility training apparatus is fixed to a wall, wherein the training means 2 is movable up and down along the wall.

In the preferred embodiment of the invention, the mobility training apparatus 1 is free-standing (FIG. 3). In order to enhance the effect of the training means 2, it is advantageous if the user can hold on to the mobility training apparatus 1 and stabilize so that his body can exert pressure on the stretched muscle M and thus on the muscle fascia. For this purpose, an embodiment of the mobility training apparatus 1 comprises holding means 4, e.g. handles, supports, tubes and wedges on the floor on which the user can hold on and brace in order to stand stably in place. In a preferred embodiment, these holding means 4 have struts 41 with cross-members or rungs 42 mounted vertically and horizontally relative to the training means 2, which the user can use to stabilize without substantial effort. These rungs can be displaceable vertically and horizontally depending on the size of the user. Any other forms of holding means 4 such as handles, supports, wedges, ladders with rungs or grids may be connected to the vertical guide 3 to allow the user to stabilize. Depending on the embodiment, the connection between the vertical guide 3 and the holding means 4 may be at the bottom, at the upper end of the vertical guide 3 or at one or even both sides of the training means 2. This connection can also be simultaneously part of the holding means 4. In one possible embodiment, a bottom plate 43, on which the user stands, is provided in the lower region of the mobility training apparatus. The weight of the user stabilizes the mobility training apparatus 1, so that it is not necessary to firmly anchor the mobility training apparatus 1 to the floor or to a wall to avoid it being displaced or even overturned by the force exerted by the user against it. In a further embodiment, a wedge is mounted at the lower end of the guide 3 as a holding means 4, against which the user can brace with the feet in order to maintain the desired stable position.

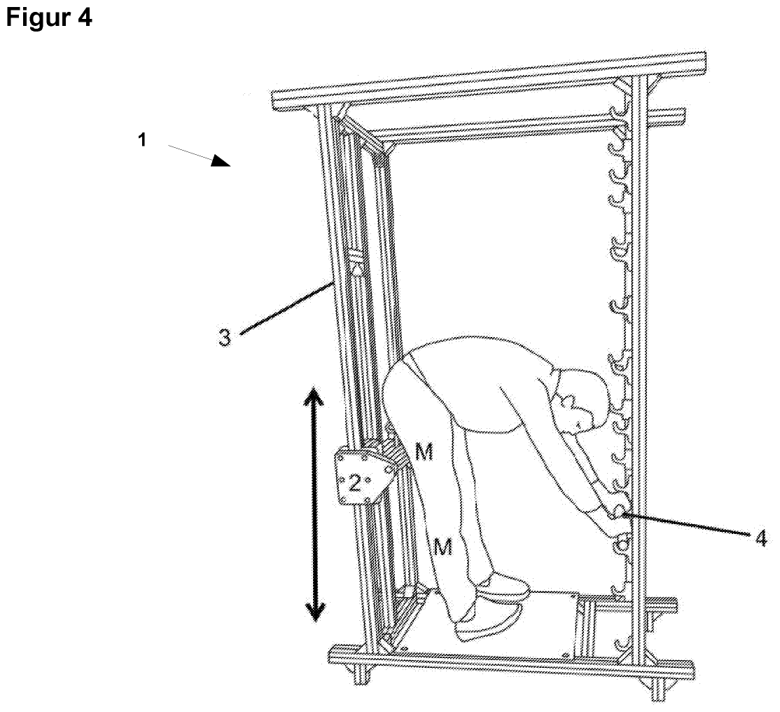

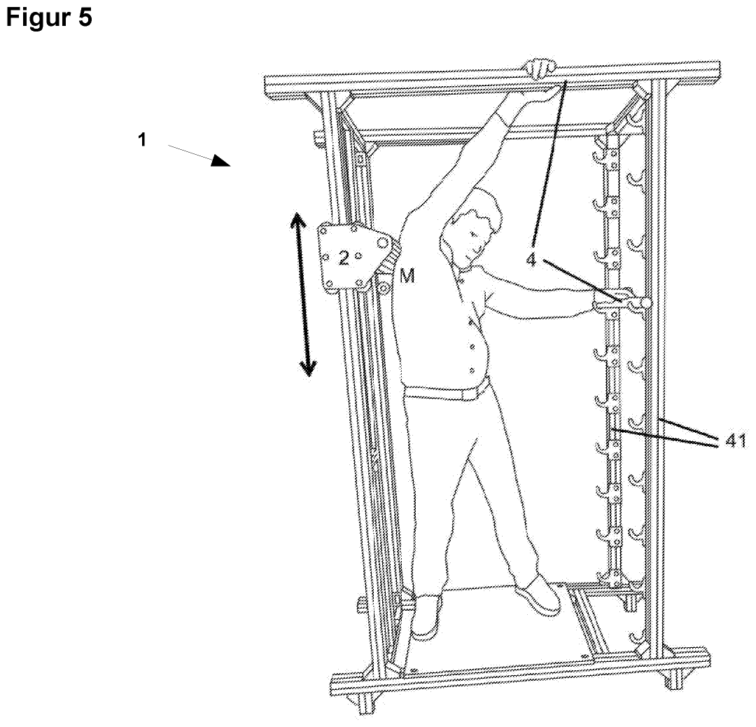

Possible uses of the mobility training apparatus 1 according to the invention are shown in FIGS. 3, 4 and 5. For example, if the leg musculature M is to be stretched and trained, the user may lean forward away from the mobility training apparatus 1 and lean against the training body 21 with the rear of one or both legs (FIG. 4). The vertical movement can happen either only in the area of the thigh, of the lower leg or over the entire length of the whole leg. To stretch and train the lateral trunk musculature, the user positions himself sideways to the mobility training apparatus 1, extending the arm facing the training body 21 upwards and away from the mobility training apparatus 1 (FIG. 5). In this case, the training body 21 is to be moved up and down between the hip bone and the upper part of the rib cage. Many other known standing or sitting positions for stretching muscles M are also possible, the only condition being that the muscle to be stretched M and its muscle fascia must be facing the training body 21.

In an advantageous embodiment of the invention, the struts 41 of the holding means 4 are curved struts 41 at least on the front of the mobility training apparatus 1 and connect the upper end of the guide 3 with the bottom plate 43. It is particularly advantageous if the curved struts 41 are crossed, i.e. a first strut 41 connects the upper right end of the guide 3 with the front left corner of the bottom plate 43 and another strut 41 connects the upper left end of the guide 3 with the front right corner of the bottom plate 43. Experiments have shown that the curved shape of these struts 41 has a vibration-damping effect on the mobility training apparatus 1. An even better damping of the vibrations resulting from the massaging, tapping or vibration of the training body 21 and from the movement of the training means 2 along the guide 3 has been achieved by crossing the curved struts 41 as described above. The curved shape gives the struts 41 an elastic or flexible effect, which is additionally reinforced by the crossing of the struts 21 in a single connection point 411. This elastic or flexible connection between the guide 3 and the bottom plate 43 absorbs the vibrations.

1. A mobility training apparatus comprising:
a vertical guide and a training device guided in the vertical guide for training muscles M and muscle fascia of the human body, characterized in that the training device comprises at least one elongate training body and is automatically movable in the guide up and down in the vertical direction by a drive.

2. The mobility training apparatus according to claim 1, wherein:
the training body is rotatable about its longitudinal axis (L).

3. The mobility training apparatus (1) according to claim 1, wherein:
the training body is vibratable.

4. The mobility training apparatus according to claim 1, wherein:
the training body includes at least one of a plurality of balls and a plurality of rollers of different thickness including at least one of a plurality of nubs with round, wavy or spiral elevations.

5. The mobility training apparatus according to claim 1, wherein:
the training body has at least five rods spaced at regular intervals about the longitudinal axis (L) of the training body and parallel thereto, the bars having a plurality of balls or rollers which are freely rotatable around the five rods or rigidly secured thereto.

6. The mobility training apparatus according to claim 1, wherein:
the training body has a polygonal profile.

7. The mobility training apparatus according to claim 1, wherein
the training body includes two or more independently rotating, vibrating or tapping parts.

8. The mobility training apparatus according to claim 1, wherein:
the training device has at least two training bodies.

9. The mobility training apparatus according to claim 1, wherein:
a holding device is firmly connected to the vertical guide, so that the user can stabilize in a stretching position.

10. The mobility training apparatus according to claim 9, wherein:
the holding device has a plurality of struts with a plurality of rungs.

11. The mobility training apparatus according to claim 9, wherein:
the holding device has the plurality of struts which are curved on a front side of the mobility training apparatus and which connect an upper end of the guide to a bottom plate.

12. The mobility training apparatus according to claim 11, wherein:
the plurality of struts are crossed.

13. The mobility training apparatus according to claim 10, wherein:
the holding device has the plurality of struts which are curved on a front side of the mobility training apparatus and which connect an upper end of the guide to a bottom plate.

14. The mobility training apparatus according to claim 13, wherein:
the plurality of struts are crossed.
